(19) United States
(12) Patent Application Publication
(10) Pub. No.: US 2009/0133268 A1
(43) Pub. Date: May 28, 2009

(54) Grip-over knife

(76) Inventors: Thomas Stroud Chambless, III, Chelsea, AL (US); Jeffrey Stroud Chambless, Pelham, AL (US)

Correspondence Address: Thomas Stroud Chambless, III, P.O. Box 39, Chelsea, AL, 35043, US

(21) Appl. No.: 12/313,619

(22) Filed: Nov. 22, 2008

Related U.S. Application Data
(60) Provisional application No. 61/004,167, filed on Nov. 26, 2007.

(51) Int. Cl. B26B 3/00

(52) U.S. Cl. 30/165

(57) ABSTRACT

The present invention is a culinary knife, intended for one handed use, comprising a handle and a blade having a cutting edge as its bottom perimeter. The entire length of the handle of the knife is joined contiguously against the spine of the blade leaving no aperture between them. This joining of the handle and blade results in the user gripping onto rather than around the handle of the knife. The handle does not extend beyond the rear of the blade, thus the user grips the knife above part of the cutting edge. This provides the user the ability to apply direct downward force for cutting and provides enhanced ability to use the palm and digits to apply finely directed force and movement to the knife. Both the location of the user hand and its proximity to the blade further enhance fine control and ease of use of the knife.

### BACKGROUND OF THE INVENTION

The present invention is a culinary knife and cutlery unit intended to be used for the cutting of foodstuffs which are placed on a cutting board or other foodstuff supporting surface.

Commonly used existing culinary knives, and other such knives which we are aware of, each have specific limitations. For example, the chef's knife and similar knives with the handle extended rearward of the blade are useful for carving and slicing foodstuffs, but usable to apply force directly down from the handle to the blade as is optimal for chopping. Also, due to the distance between the handle and the blade, and the effort needed to orient and move the knife to desired positions, the degree of fine control over the movement and cutting action of such knives is limited.

In contrast to the chef's knife and similar knives, the mezzaluna and similar culinary instruments are able to receive direct downward force for effective cutting, which is especially useful for chopping. However, such knives are usually not very effective for finely controlled culinary cutting applications such as slicing or carving.

This invention offers the user many abilities and benefits of the aforementioned culinary knives as well as fine control of knife movement. The benefits come from: the handle being joined contiguously to the spine of the blade with no aperture between, the proximity of the handle to the cutting edge, and the required placement of the hand and digits on the back and lateral sides of the knife for gripping. The present invention gives effective results for finely controlled and dexterous application of slicing and carving and for application of direct downward force applied for chopping.

By considering our prototype trials we recognize that our invention will be an aid for many culinary knife users in general due to the ability to apply force directly down from the handle to the blade. All these considerations enhance the comfort in use and ease of use for the user of this knife.

In testing the concept of our invention, we found that limiting the handle to the spine of the knife provides the user control of the knife and the ability to readily apply force to the cutting edge, both abilities being beyond what we have previously seen offered in a single knife unit. Our invention places the gripping hand in close proximity to the blade edge in combination with the fine dexterous usage of the digits for blade edge direction and cutting force employment.

Our invention offers more fine control than either the mezzaluna type cutter or the chef's knife or other culinary knives due to the unique gripping location of out invention and the placement of its handle. We recognized that securing the handle on the back of our invented knife rather than having the handle extend beyond the rear enables excellent user control of the knife.

Commonly used culinary knives do not provide great variability in intended gripping. While users may modify their grip of such knives by applying the hand closer to the blade edge or onto part of the spine of the blade, this is not apparently intended by the handle structure of such knives. In contrast, our invention offers to the user variety in gripping options that provide enhancements to several specific cutting actions.

Users can have trouble manipulating a standard culinary knife which often has total length almost twice as long as the user hand, often up to about fifteen inches. This is in part due to the handle length adding length to the total knife length beyond the blade. We recognized that, with our invention, by placing the handle contiguously on the blade and not extending rearward beyond the blade, we can create a knife unit with the same blade length of a given existing knife without the additional length of a handle extending beyond the blade.

There are existing knives usable for some culinary applications and which may offer some of the benefits of the present invention, yet generally lack the combination of culinary use benefits provided by the present invention. We have recognized the need for such a culinary knife and therefore have invented a knife which offers fine control, which offers the ability to cut by user application of direct downward force, and which offers variations in useful grip. For these reasons, we have concluded that our invented knife offers many advantages.

### BRIEF SUMMARY OF THE INVENTION

### Object of the Invention

The object of the present invention is to be a novel culinary knife and cutlery unit that enhances the user experience of available cutting actions in multiple ways as follows:

The object of the present invention is to allow the user to be able to exert downward force in cutting use directly from the handle to the cutting edge without any need to mitigate or adjust this force. This force is intended to be applied by the palm and the digits. The object is also for the user to also be able but not required to effectively exert other needed forces to be applied to the cutting edge to manipulate and control the knife.

The object of the present invention is to provide a high degree of fine user control of the knife. This fine control may also be thought of as dexterous use of the knife. This is intended to be accomplished largely in two ways. First, the digits are able to be applied for gripping the knife in such fashion as to exert a novel degree of fine control over movements and direction. This is due to the digits exerting collective and autonomous pressure on the knife that is usable to control position and movement of the knife, and force applied to the knife. Second, the entirety of the grip is to be above and in close proximity to the blade, allowing a variety of methods of applying force and control to the knife, enabling enhanced control of knife movement and cutting.

The object of the present invention is to create a knife that allows users to perform knife cutting actions more easily and with more comfort. This ease and comfort is provided from offering the user many options in gripping the knife and in applying force. The ease and comfort is also provided by the user's ability to apply effective force on the knife which is aided by the proximity of the gripping hand to the cutting edge when the knife is in use.

The object of the invention is to create a knife that is graspable in multiple ways, all of which are effective for use of the knife. The handle placement on the spine of the blade allows the user to grip the knife in a variety of ways that allow effective use of the knife.

### Nature and Substance of the Invention

The present invention is a single bladed knife that is able to be used and manipulated for its use by one hand. The knife is made to be used for culinary applications along with a supporting surface.

This knife has a standard knife cutting edge which is a sharpened edge of the blade. The blade is elongated and its total length has a blunt spine and a cutting edge opposite the spine. The blade and handle component materials consist of suitable knife component materials.

The knife is constructed such that its handle is joined directly against its blade spine for the entire length of the handle. This places the handle in close proximity to the cutting edge of the knife. The handle does not extend forward to the blade front end or rearward beyond the butt end of the blade. The handle extends rearward to about the butt end of the knife.

The construction is such that the handle is the basis of user grasping and manipulation of the knife. Additionally, the user can place digits on the spine or sides of the knife. The knife must be gripped without the hand extending completely around the handle due to the blade extending from the handle. The grip for use of the knife requires the hand to be placed over, onto, and against the knife surfaces.

### DETAILED DESCRIPTION OF THE INVENTION WITH REFERENCE TO THE DRAWINGS

In reference to the drawings, FIGS. 1-3 illustrate from the side, top, and front the construction of our invented knife unit as herein described. The present invention is a novel culinary knife unit comprising an elongated blade 6 and an elongated handle 2 generally parallel to each other, having the total length of the handle joined longitudinally onto and contiguously connected directly against and over the spine 5 of the blade 6. This invention has no aperture or other opening between the handle 2 and blade 6. The present invention is intended to be used as a food cutter knife for use for raw or cooked foodstuff preparation.

The blade 6 of the present invention is made having a usable sharpened cutting edge 7 as one elongated perimeter and an elongated blunt spine 5 as its elongated perimeter side opposite the cutting edge 7. The spine 5 and cutting edge 7 join at the distal front end of the blade 6 in a manner suitable for making a culinary knife. This joining at the distal end can include the spine 5 and cutting edge 7 joining directly to each other. The spine 5 and the cutting edge 7 join to the butt end 4 perimeter side of the blade 6 being the proximal side of the blade 6. The spine 5 may be shaped in various sizes or shapes. The cutting edge 7 is straight or convex or a combination of the two such that it is usable for culinary cutting. The cutting edge 7 extends from the front of the blade to about the butt end 4 of the blade 6. The rear end of the handle 3 extends generally to the butt end 4 perimeter side of the blade 6.

There are no extensions of the blade 6 rearward beyond the butt end 4 perimeter side of the blade 6. The butt end 4 of the blade 6 is the proximal termination of the blade.

The spine 5 is formed straight or curved or having angles or a having a combination of these forms. The cutting edge 7 can be straight or angled or curved or having a combination of these shapes or forms. The handle 2 can be shaped being straight or curved or having one of various angles or a combination of these forms.

Within the above parameters, the blade 6 may be shaped similar to the blade of an existing culinary knife. The knife type known as the “chefs knife” form or a similar blade form may be used for making one of the more effective specimens of the present invention. Additional and various forms of blades may be used for constructing this invention provided such forms are suitable for culinary cutting use.

The blade 6 of the present invention can be made of metal, stone, or any other material suitable for making a culinary knife blade.

We herein refer to the segment of the blade 6 under the handle 2 as the “under-blade” and the segment of the blade 6 forward of the handle 2 as the “fore-blade.” Together these two segments compose the total usable blade 6 surface. Each blade 6 section has somewhat different utility. Both of these blade 6 segments are usable for cutting either separately or concurrently. The forces applied to any segment or to the whole of the blade 6 be may be adjusted by the placement of the palm and digits on the knife.

The under-blade is able to receive and transfer direct downward force for cutting use of the knife. The inventors consider the under-blade to be especially useful for but not limited to chopping. The under-blade gives the user the advantage of being able to apply usable direct downward force that is not available on existing culinary knives. Generally downward force can be applied to the under-blade in addition to forward and rearward force, lateral force, and torque for cutting application.

The fore-blade is able to receive and transfer generally downward force which is applied and directed forward to the cutting edge 7. The inventors consider the fore-blade to be especially useful for but not limited to slicing, carving, and fine use of the cutting edge. There is no part of the handle 2 above the fore-blade segment of the blade 6. Generally downward force can be applied to the fore-blade in addition to forward and rearward force, lateral force, and torque for cutting application.

The handle 2 is the basis of grasping the knife by the user for manipulation and use of the knife. The handle 2 is of sufficient length to be the basis of the user grasping the knife. It is an elongated member of the knife which is fixed to the spine 5 by manufacture or is fixable securely by the user onto the spine 5. The handle 2 may extend against and cover areas of the sides of the blade 6 adjacent to the spine 5. The handle 2 is shorter than the blade 6 and does not extend forward for the entire length of the blade 6. A portion of the blade 6 extends forward of the handle 2. The handle rear end 3 extends rearward to be about even with the butt end 4 of the blade 6 of the knife.

The handle 2 may be rigidly secured and fixed to the blade 2 in a permanent fashion. The handle 2 may be user fixable onto the blade 6 with its position within the parameters of this invention. The handle 2 may be formed as an expansion of the spine 5, being one piece with the knife blade 6, which results in the handle 2 and blade 6 being all of the same material. The handle 2 may be constructed of one part or of multiple parts for making the whole of the handle 2. The handle 2 may be made of various sizes and shapes and forms and does not extend rearward beyond the butt end 4 of the blade 2 sufficiently to aid in the gripping of the knife. The handle 2 length my be similar to the existing knife handle sizes or may be made shorter or longer. The handle 2 may have tapered surfaces on the top of its front and sides such that its surfaces evenly join at the equivalent surface level of the adjacent blade 6 sides and spine 5 surfaces to enable the user to readily extend digits onto the blade 6 or spine 5 to aid in the control of the knife. The handle 2 may be made of any material proven adequate and usable for making culinary knife handles.

Specimens of the present invention may be made having the handle 2 made with various sizes, shapes, and forms of raised or indented shapes on the surface of the handle 2 to facilitate gripping of the knife. The handle 2 may be made having raised surfaces along the length of the handle 2 being at about the lowest handle 2 areas above the blade 6 for protection of the digits from the cutting edge 7. Such protective surfaces may also further facilitate the gripping of the handle 2.

The knife may be made having interchangeable handles 2 which may be fixed to the blade 6 by the user by screws, clamps, or other suitable fasteners for connecting the handle 2 to the blade 6. The handle 2 may be made to be interchangeable for altering the type, size, shape, and form of the handle 2 for specific uses of the knife.

As with the majority of knives known to the inventors, the palm is intended to be positioned on the back 1 of the handle for normal and effective gripping of the knife. For gripping, the digits may all grip on the handle 2, or some may also grip on the blade 6. This knife is readily gripped either onto the handle 2 only or onto both the handle 2 and the blade 6 together. Any portion of the length of the knife handle 2 is available for the user placement of the hand to grip the knife. The knife structure requires the user hand to be gripped against the knife unit surfaces by grasping onto and against the back and sides of the knife. This knife structure disallows gripping such that the hand fully encircles the handle 2.

Attributes of the Invention that are New to the Art

The mode of gripping this invention results in the user holding the knife in such fashion to provide fine control over movement and application of force to the knife, which enhances the dexterity the user may apply to the knife. Such fine control is available to the user for chopping, slicing, carving, and any other movement of the knife the inventors are aware of. This fine control is achieved in part by the hand being closer to any part of the blade 6 than the hand would be on a comparably sized knife without the handle 2 connected directly against and above the blade 6. This fine control is also achieved in part by the gripping parameters that result in the digits being placed on the back of the handle 1, on the spine 5, or on the lateral sides of the blade 6, and thus the digits are able to control lateral force and torque with enhanced precision. This fine control is enhanced by autonomous and concurrent control of knife movement by the digits due to the positioning of the digits on the knife when gripping the knife.

The knife is constructed such that the user can apply force directly downward from the properly gripped hand for effective cutting by the cutting edge 7. The knife can also cut with standard motions and movements used on existing culinary knives. There is no part of the handle 2 that does not have part of the blade directly under it. Therefore, any force applied directly downward to the handle 2 or blade 6 forces the whole blade 6 directly downward, and enables its use for cutting. The ability to apply downward force is versatile and this force can be applied at various angles or in combination with other movements or forces. Downward force on the handle 2 is applied from the hand directly above a portion of the blade 6 and is applied directly down to the blade 6, and this force is transferred directly downward to the whole or any part of cutting edge 7 being applied to cut. The downward force is finely adjustable by the user hand and the hand position on the handle 2. This ability to apply directly downward force facilitates the cutting of most common foodstuffs.

Because the handle 2 is completely placed on the spine 5, any part of the handle 2, and thus the whole of the handle 2, is in closer proximity to the blade 6 in general than if the same handle 2 were extended beyond the rear of the blade 6. This places the handle 2 and the user hand, when gripping the knife, in close proximity to the blade 6. The handle 2 is directly above a segment of the cutting edge 7, and thus is close to it. Also, since a segment of the blade 6 is under the handle 2, only part of the blade 6 rather than the whole extends forward of the handle 2 meaning that the handle 2 is also close to the forward part of the blade 6. The close proximity between the gripping hand to the cutting edge 7 of the present invention allows efficient control of the knife.

The construction of this knife entails the user can not totally encircle the handle 2 with the hand because the blade 6 protrudes from the underside of the handle 2 and there is no aperture between the handle 2 and blade 6. Therefore, gripping of this knife is onto and against the handle 2, rather than encircling it, which is, to our knowledge, new to the art of culinary knives. The gripping of the knife unit is done in a similar manner to gripping onto a stout hand rail by applying the hand parts to clasp over and onto and against the back and side surface areas of the knife unit. For safety reasons, with all intended and safe gripping positions of this knife, no part of the hand extends to or below the cutting edge 7.

Why this Knife is Different from Existing Culinary Knives

On known culinary knives the hand placement is limited to generally gripping around the handle 2, with possible minor variations. Other modes of gripping are often inconvenient and, to the inventors' knowledge, rarely used. With the present invention the hand is able to grip in multiple fashions and positions, especially with the placement of the digits, which are placeable in multiple positions onto the upper areas of the knife for proper gripping. This allows autonomous digit placement and use in control of the knife. A result of the construction of the knife is the variable digit placement onto either the handle 2 or onto the handle 2 and the blade 6 for user manipulating and using the knife unit. The thumb and first two digits are placeable in multiple positions on the knife, at the discretion of the user, and each desired position can offer advantages of controlling the knife for specific applications of the knife. Various grips can be used to affect the facility with which various cutting motions can be performed.

The construction of the present invention results in a shorter overall unit lengthwise compared to an existing culinary knife which has a handle protruding from its rear and has an equal sized blade. The present invention has a shorter overall length by not having the handle 2 extending rearward beyond the butt end 4 of the blade 6.

The method of gripping the knife and the proximity of the hand to the cutting edge 7 enhances: user control of the knife, ease of use of the knife, user comfort in use of the knife, fine control of the application of force to the cutting edge 7, and the ability to cut with direct downward force applied by the knife to foodstuffs, all of which can make foodstuff cutting more easily accomplished.

This knife offers effective results combined in one unit for both finely controlled application of slicing, carving, and chopping, for direct downward cutting applications, and for any other desired cutting that the knife offers.

### Manner of Using the Invention

The knife is intended to be used for slicing, carving, chopping, and other cutting of foodstuff objects on a supporting cutting surface and is intended to be positioned for cutting use with the handle 2 above the cutting edge 7.

This knife is intended to be primarily gripped on the back and sides of the handle 2 with the option available of additionally gripping adjacent sides of the blade 6. The grip must be onto and against the handle 2 or onto and against both handle 2 and blade 6 surfaces without the grip being an encircling grip. The grip is made secure by applied opposing clutching forces from parts of the hand to other parts of the hand for creating a friction grasp onto, against, and over the surfaces of the knife. Intended gripping onto the present invention for its effective cutting use has the user gripping palm positioned on the handle back 1 with the digits positioned adjacent the palm. One handed gripping of the knife is sufficient to enable the user to perform all cutting actions this knife can perform.

In intended use, the digits grip by squeezing and pressing against the knife surfaces to apply lateral force diametrically opposite to each other part of the hand. These opposing forces help secure the grip. The index finger is the only effective exception to this diametrically opposed digit grip, as the index finger is readily able to press downward on the spine 5.

The present invention allows one or two or three of the user thumb and index and second fingers of the user gripping hand to grip onto areas of the forward portion of the handle 2 or onto a combination of this stated handle 2 area and areas of the blade 6 adjacent to the handle 2. The thumb can be gripped onto and held against one side of the handle 2 and applies pressure against the handle 2 and optionally the blade 6. This pressure applied by the thumb is toward other digits positioned on the opposite side of the knife. Some of the fingers are intended to be gripped onto and held against the side of the handle 2 opposite that side gripped by the thumb, and the fingers apply pressure against the handle 2 and optionally the blade 6. This pressure is toward the thumb on the opposite side of the knife. The third and fourth fingers are intended to press against the handle 2 and opposite the palm for normal use of the knife. The forefinger and second finger can be pressed against the handle 2 along with the third and fourth fingers. The forefinger or the forefinger and second finger together can be extended forward of the handle to press against the side of the blade 6 opposite the thumb. The forefinger can optionally be placed on the spine 5 of the blade. The longitudinal orientation of the palm on the handle 2 determines the placement of the digits onto the handle 2 or blade 6. Various positions of grip allow the user the ability to more finely control the aspects of movement of the knife.

The present invention is intended to be used to cut stationary foodstuffs placed on a generally horizontal supporting surface, such as a cutting board or countertop, which sufficiently holds the foodstuff during cutting.

This knife is able to be used to perform standard cutting movements that known culinary knives can do. This knife can perform slicing, chopping, shaving, or carving, and other culinary cutting movements. In addition to movements other culinary knives can perform, with the present invention the user can create significant usable leverage on the blade 6 when the rear of the cutting edge 7 is placed on the cutting surface as a temporary fulcrum and force is exerted directly downward from the hand to the knife. This leverage is sufficient enable the user to achieve many culinary cutting uses with the knife.

While we have disclosed and described a particular embodiment of the invention, it should be apparent to one skilled in the art that modifications and variations may be made without deviating from the principles, spirit, and scope of the invention. Therefore, we claim as our invention all such modifications and specimens as may be made within the scope and spirit of the appended claims.

### BRIEF DESCRIPTION OF THE DRAWINGS

In the accompanying page of drawings:

FIG. 1 is a side view of the knife depicting the blade, the handle, the parts thereof, and depicting one configuration of the contiguous connection between the two, showing an example of the invention.

FIG. 2 is a top view of the knife depicting the top of the handle and the spine of the blade.

FIG. 3 is a front view of the knife depicting the handle and the spine and the cutting edge and the blade from the front end.

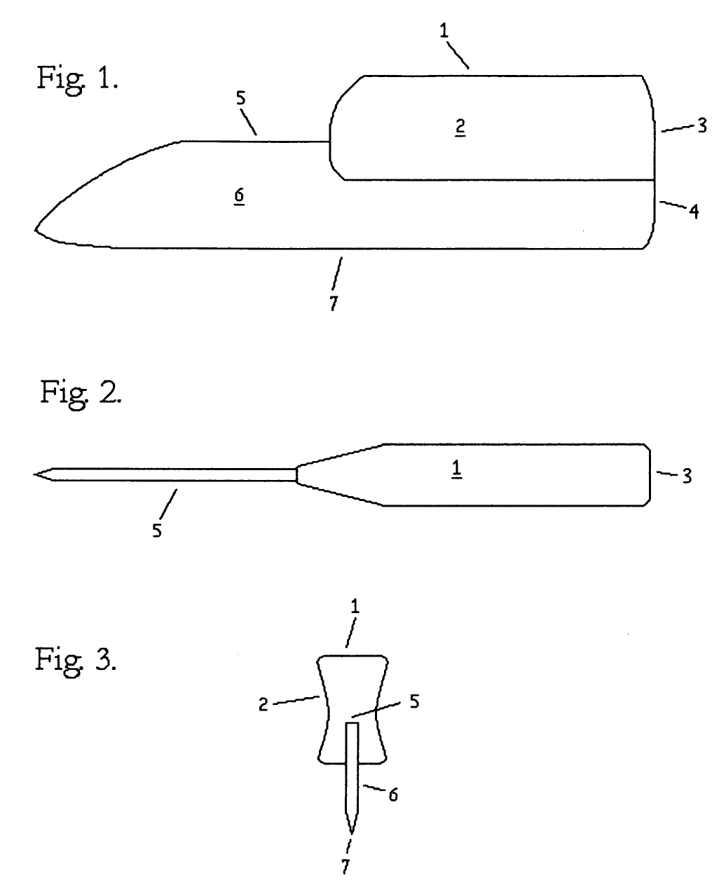

What is claimed is:

1. A knife unit constructed with a blade of functional size, shape, and form to be suitable and effective and usable for culinary cutting, and constructed with the blade having a blunt spine as one elongated perimeter side and a sharpened cutting edge as another elongated perimeter side with the spine and the cutting edge being opposite sides of the blade, and constructed with the spine and the cutting edge joining at the proximal end of the blade to a blunt butt end which is the proximal perimeter side of the blade, and constructed such that the blade has no rearward extension beyond the butt end of the blade, and constructed with the spine and the cutting edge joining at the distal end of the blade in a fashion suitable for culinary knife use, and constructed with its cutting edge suitable for culinary cutting, and constructed with an elongated handle of sufficient length and size to be the primary part of the knife which is used for the grasping and manipulation of the knife, and constructed with the total length of the handle being connected and joined contiguously to the blade against a longitudinal segment of the spine of the blade, and constructed with the blade extending from below the handle such that there is no aperture between the blade and the handle, and constructed with the handle located directly opposite a segment of the cutting edge, and constructed with the handle rear end extending generally to and terminating at about the butt end of the blade, and constructed with the handle front end extending only partway along the spine toward the front end of the blade such that a usable portion of the cutting edge of the blade extends forward of the handle.

2. The knife of claim 1 whereas the total length of the handle is connected and joined contiguously to the blade against longitudinal segments of the sides of the blade that are adjacent to the spine in addition to the handle being connected and joined contiguously to the spine.

3. The knife of claim 1 whereas the knife handle is connected to the blade allowing an adequate area of the blade between the handle and the cutting edge so as to not interfere with the cutting utility of the blade and the cutting utility of the portion of the cutting edge that is located directly below the handle.

4. The knife of claim 1 whereas the knife handle is made a suitable size and shape and form for culinary use and the handle component materials are suitable and usable material for making a culinary knife handle.

5. The knife of claim 1 whereas the blade and its spine and its cutting edge are made a suitable size and shape and form for culinary use and blade component materials are suitable and usable for culinary knife use.

6. The knife of claim 1 whereas the spine perimeter and the cutting edge perimeter join at the distal end in a fashion suitable for a culinary knife.

7. The knife of claim 1 whereas the knife has a segment of the cutting edge directly below the total length of the handle and the knife has a segment of cutting edge forward of the fore end of the handle and both segments together comprise the whole of the length of the cutting edge and both segments are effective for cutting either separately or concurrently and each section offers distinct differences of cutting utility and also differences in the required user application of force for cutting.

8. The knife of claim 1 whereas the segment of the cutting edge directly below the total length of the handle is usable for cutting by the user applying directly downward force in addition to other forces applied to the knife.

9. The knife of claim 1 whereas the segment of the cutting edge forward of the handle is usable for cutting by the user applying downward force that is directed forward in addition to other forces applied to the knife.

10. The knife of claim 1 whereas the knife can be sufficiently gripped for cutting use by one hand, and the intended method of gripping is based on the user placing the palm of one hand on the handle of the knife and placing the digits of the same hand on some combination of the handle, the blade, and the spine of the knife, resulting in a user hand placement directly above some usable segment of the cutting edge.

11. The knife of claim 1 whereas the absence of aperture between blade and handle disallows the hand gripping such that it is fully encircling against the bottom of the handle, due to the fact that the blade location and its extension from the handle necessarily prevents and precludes such a grip, resulting in gripping of the knife that is based on parts of the hand applying pressure upon the knife that opposes other parts of the hand by constricting and squeezing and exerting pressure onto and against surfaces of the back and sides of the knife to secure the grip of the knife.

12. The knife of claim 1 whereas the handle position on the spine of the blade results in each part of the handle and the whole of the handle being in closer proximity to the blade and cutting edge in general than would be attainable if the whole of the same handle were extended beyond the rear of the blade, and this position of the handle results in the user hand being in close proximity to the blade and to the cutting edge when placed on the handle for grasping the knife, and this proximity of the hand to the blade edge provides the user readily applicable fine control of the movements and use of the cutting edge.

13. The knife of claim 1 whereas fine control of this knife for cutting use is given to the user by the handle placement directly against the blade and by the resultant user gripping of the knife, both of which enable the user by independent and concurrent palm and digit movements to finely adjust: knife orientation and precise placement of the knife blade edge and the direction of knife blade edge movement and the magnitude of applied force and the direction of applied force upon the knife unit and its blade edge for cutting use and torque force, lateral force, and other directional forces and the pitch, yaw, and roll of the knife.

14. The knife of claim 1 whereas when gripping the knife and orienting the knife for cutting with the cutting edge placed on a foodstuff object, the user can apply directly downward force to the handle, to the spine, and to the blade that is transferred downward to the cutting edge and directly to any applied part of the cutting edge directly below the handle which results in useful and effective knife movement for cutting the foodstuff.

15. The knife of claim 1 whereas when gripping the knife and orienting the knife for cutting with the cutting edge placed on a foodstuff object, the user can apply generally downward force to the handle, to the spine, and to the blade that is transferred downward to any applied part of the cutting edge, including the part of the cutting edge forward of the handle, which results in useful and effective movement for cutting the foodstuff.
